(19) United States
(12) Patent Application Publication
(10) Pub. No.: US 2020/0117390 A1
(43) Pub. Date: Apr. 16, 2020

(54) DATA STORAGE DEVICE AND OPERATING METHOD THEREOF

(71) Applicant: SK hynix Inc., Gyeonggi-do (KR)

(72) Inventors: Hye Mi KANG, Gyeonggi-do (KR); Eu Joon BYUN, Gyeonggi-do (KR); Byung Jun KIM, Gyeonggi-do (KR)

(21) Appl. No.: 16/415,712

(22) Filed: May 17, 2019

(30) Foreign Application Priority Data
Oct. 16, 2018 (KR) 10-2018-0123378

(51) Int. Cl. G06F 3/06

(52) U.S. Cl. CPC G06F 3/0659; G06F 3/0604; G06F 3/0679; G06F 3/0647; G06F 3/0652

(57) ABSTRACT

A data storage device may include: a nonvolatile memory device including a first data storage region and a second data storage region which have different endurances, and the nonvolatile memory device configured to perform one or more of an erase operation, a write operation and a read operation on the first and second data storage regions; and a controller configured to determine whether an update event in which second data stored in the second data storage region is changed occurs, and control the nonvolatile memory device to transfer the second data to the first data storage region, based on the update event determination result.

### CROSS-REFERENCE TO RELATED APPLICATION

The present application claims priority under 35 U.S.C. § 119(a) to Korean application number 10-2018-0123378, filed on Oct. 16, 2018, in the Korean Intellectual Property Office, which is incorporated herein by reference in its entirety.

### BACKGROUND

### 1. Technical Field

Various embodiments of the present invention generally relate to an electronic device. Particularly, the embodiments relate to an electronic device including a controller and a non-transitory machine-readable storage medium.

### 2. Related Art

A memory system may be configured to store the data provided from an external device, in response to a write request from the external device. Also, the memory system may be configured to provide stored data to the external device, in response to a read request from the external device. The external device, as an electronic device capable of processing data, may include a computer, a digital camera or a mobile phone. The memory system may be disposed in the external device, or may be a separate component coupled to the external device.

Since there is no mechanical driving part, a memory system using a memory device provides advantages such as excellent stability and durability, high information access speed, and low power consumption. Memory systems having such advantages include a universal serial bus (USB) memory device, memory cards having various interfaces, a universal flash storage (UFS) device, and a solid state drive (SSD).

### SUMMARY

Various embodiments are directed to a wear leveling technique for effectively extending the lifetime of a memory device.

In an embodiment, a data storage device may include: a nonvolatile memory device including a first data storage region and a second data storage region which have different endurances, and the nonvolatile memory device configured to perform one or more of an erase operation, a write operation and a read operation on the first and second data storage regions; and a controller configured to determine whether first data stored in the first data storage region is cold data, and control the nonvolatile memory device to transfer the first data to the second data storage region, based on the cold data determination result.

In an embodiment, a data storage device may include: a nonvolatile memory device including a first data storage region and a second data storage region which have different endurances, and configured to perform one or more of an erase operation, a write operation and a read operation on the first and second data storage regions; and a controller configured to determine whether an update event in which second data stored in the second data storage region is changed occurs, and control the nonvolatile memory device to transfer the second data to the first data storage region, based on the update event determination result.

In an embodiment, an operating method of a data storage device may include the steps of: determining whether first data is cold data, the first data being data stored in a first data storage region included in a nonvolatile memory device; deciding whether to transfer the first data, based on the cold data determination result; and controlling the nonvolatile memory device to transfer the first data to a second data storage region, based on the first data transfer decision result, the second data storage region being included in the nonvolatile memory device and having different endurance from the first data storage region.

In an embodiment, an operating method of a data storage device may include the steps of: determining whether an update event for second data occurs, the second data being data stored in a second data storage region included in a nonvolatile memory device; deciding whether to transfer the second data, based on the update event determination result; and controlling the nonvolatile memory device to transfer the second data to a first data storage region, based on the second data transfer decision result, the first data storage region being included in the nonvolatile memory device and having different endurance from the second data storage region.

In an embodiment a data storage device comprising: a nonvolatile memory device including first and second storage regions respectively storing first and second data; and a controller that controls the nonvolatile memory device to: move the second data into the first storage region when the second data is updated; store externally provided data that is initially not stored in the data storage device into the second storage region; and move the first data into the second storage region when the first data becomes cold data.

### BRIEF DESCRIPTION OF THE DRAWINGS

FIG. 1 illustrates a configuration of a data storage device 10 in accordance with an embodiment.

FIG. 2 illustrates a memory, such as that of FIG. 1.

FIG. 3 is a diagram illustrating a data storage region included in a nonvolatile memory device in accordance with an embodiment.

FIG. 4 is a diagram illustrating a wear leveling manager of a flash translation layer (FTL) in accordance with an embodiment.

FIG. 5 is a flowchart illustrating a wear leveling management method in accordance with an embodiment.

FIG. 6 is a flowchart illustrating a wear leveling management method in accordance with another embodiment.

FIG. 7 is a flowchart illustrating a wear leveling management method in accordance with still another embodiment.

FIG. 8 illustrates a data processing system including a solid state drive (SSD) in accordance with an embodiment.

FIG. 9 illustrates a configuration of a controller, such as that of FIG. 8.

FIG. 10 illustrates a data processing system including a data storage device in accordance with an embodiment.

FIG. 11 illustrates a data processing system including a data storage device in accordance with an embodiment.

FIG. 12 illustrates a network system including a data storage device in accordance with an embodiment.

FIG. 13 is a block diagram illustrating a nonvolatile memory device included in a data storage device in accordance with an embodiment.

### DETAILED DESCRIPTION

A data storage device and an operating method thereof are described below with reference to the accompanying drawings through various embodiments. Throughout the specification, reference to “an embodiment,” “another embodiment” or the like is not necessarily to only one embodiment, and different references to any such phrase are not necessarily to the same embodiment(s).

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present. Communication between two elements, whether directly or indirectly connected/coupled, may be wired or wireless, unless stated or the context indicates otherwise.

As used herein, singular forms may include the plural forms as well and vice versa, unless the context clearly indicates otherwise. The articles ‘a’ and ‘an’ as used in this application and the appended claims should generally be construed to mean ‘one or more’ unless specified otherwise or clear from context to be directed to a singular form.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

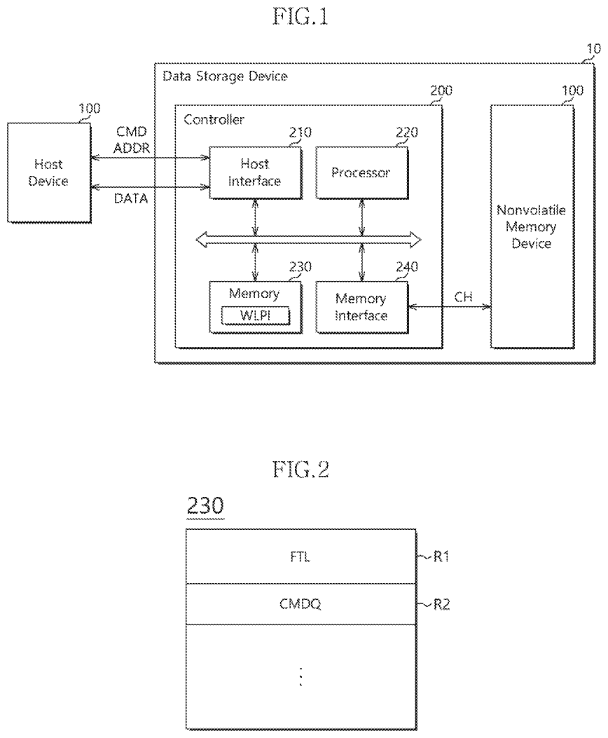

FIG. 1 illustrates a configuration of a data storage device 10 in accordance with an embodiment.

Referring to FIG. 1, the data storage device 10 may store data which may be accessed by a host device 20 such as a mobile phone, MP3 player, laptop computer, desktop computer, game machine, TV or in-vehicle infotainment system. The data storage device 10 may be referred to as a memory system.

The data storage device 10 may be configured as any of various types of storage devices, according to an interface protocol coupled to the host device 20. For example, the data storage device 10 may be configured as any of a solid state drive (SSD), a multimedia card (MMC) such as an eMMC, RS-MMC or micro-MMC, a secure digital (SD) card such as a mini-SD or micro-SD, a universal serial bus (USB) storage device, a universal flash storage (UFS) device, a personal computer memory card international association (PCMCIA) card-type storage device, a peripheral component interconnection (PCI) card-type storage device, a PCI express (PCI-E) card-type storage device, a compact flash (CF) card, a smart media card and a memory stick.

The data storage device 10 may be fabricated as any one of various types of packages, such as a package-on-package (POP), a system-in-package (SIP), a system-on-chip (SOC), a multi-chip package (MCP), a chip-on-board (COB) package, a wafer-level fabricated package (WFP) and a wafer-level stack package (WSP).

The data storage device 10 may include a nonvolatile memory device 100 and a controller 200.

The nonvolatile memory device 100 may operate as a storage medium of the data storage device 10. The nonvolatile memory device 100 may be configured as any of various types of nonvolatile memory devices including a NAND flash memory device, a NOR flash memory device, a ferroelectric random access memory (FRAM) using a ferroelectric capacitor, a magnetic RAM (MRAM) using a tunneling magneto-resistive (TMR) film, a phase change RAM (PRAM) using chalcogenide alloys, and a resistive RAM (ReRAM) using transition metal oxide, depending on memory cells.

FIG. 1 illustrates that the data storage device 10 includes one nonvolatile memory device 100. However, this is only an example; the data storage device 10 may include a plurality of nonvolatile memory devices. The present disclosure may be applied in the same manner to a data storage device 10 including a plurality of nonvolatile memory devices.

The nonvolatile memory device 100 may include a memory cell array (not illustrated) having a plurality of memory cells arranged at the respective intersections between a plurality of bit lines (not illustrated) and a plurality of word lines (not illustrated). The memory cell array may include a plurality of memory blocks, and each of the memory blocks may include a plurality of pages.

For example, each of the memory cells of the memory cell array may be a single level cell (SLC) capable of storing 1-bit data or a multi-level cell (MLC) capable of storing 2 or more-bit data. The MLC may store 2-bit data, 3-bit data, 4-bit data or the like. In general, a memory cell for storing 2-bit data may be referred to as an MLC, a memory cell for storing 3-bit data may be referred to as a triple level cell (TLC), and a memory cell for storing 4-bit data may be referred to as a quadruple level cell (QLC). Here, however, the memory cells for storing 2-bit, 3-bit and 4-bit data may be collectively referred to as MLCs for convenience of description.

The memory cell array 110 may include one or more of the SLCs and the MLCs. Furthermore, the memory cell array 110 may include memory cells with a two-dimensional horizontal structure or memory cells with a three-dimensional vertical structure.

The controller 200 may control overall operations of the data storage device 10 by driving firmware or software loaded to a memory 230. The controller 200 may decode and drive a code-based instruction or algorithm such as firmware or software. The controller 200 may be implemented in hardware or a combination of hardware and software.

The controller 200 may include a host interface 210, a processor 220, the memory 230 and a memory interface 240. Although not illustrated in FIG. 1, the controller 200 may further include an error correction code (ECC) engine which generates parity data by performing ECC encoding on write data provided from a host device, and performs ECC decoding on read data read from the nonvolatile memory device 100 using parity data.

The host interface 210 may interface the host device 20 and the data storage device 10 in response to a protocol of the host device 20. For example, the host interface 210 may communicate with the host device 20 through any of the following protocols: USB (universal serial bus), UFS (universal flash storage), MMC (multimedia card), PATA (parallel advanced technology attachment), SATA (serial advanced technology attachment), SCSI (small computer system interface), SAS (serial attached SCSI), PCI (peripheral component interconnection) and PCI-E (PCI express).

The processor 220 may include a micro control unit (MCU) and/or a central processing unit (CPU). The processor 220 may process a request transferred from the host device 20. In order to process the request transferred from the host device 20, the processor 220 may drive a code-based instruction or algorithm, i.e. firmware, which is loaded to the memory 230, and control the nonvolatile memory device 100 and internal function blocks such as the host interface 210, the memory 230 and the memory interface 240.

The processor 220 may generate control signals for controlling an operation of the nonvolatile memory device 100, based on requests transferred from the host device 20, and provide the generated control signals to the nonvolatile memory device 100 through the memory interface 240.

The memory 230 may be configured as a random access memory such as a dynamic RAM (DRAM) or static RAM (SRAM). The memory 230 may store the firmware driven by the processor 220. Furthermore, the memory 230 may store data required for driving the firmware, for example, meta data. That is, the memory 230 may operate as a working memory of the processor 220.

The memory 230 may include a data buffer for temporarily storing write data to be transferred to the nonvolatile memory device 100 from the host device 20 or read data to be transferred to the host device 20 from the nonvolatile memory device 100. That is, the memory 230 may operate as a buffer memory.

The memory interface 240 may control the nonvolatile memory device 100 under control of the processor 220. The memory interface 240 may be referred to as a memory controller. The memory interface 240 may provide control signals to the nonvolatile memory device 100. The control signals may include a command, address and operation control signal for controlling the nonvolatile memory device 100. The memory interface 240 may provide data stored in the data buffer to the nonvolatile memory device 100 or store data transferred from the nonvolatile memory device 100 in the data buffer.

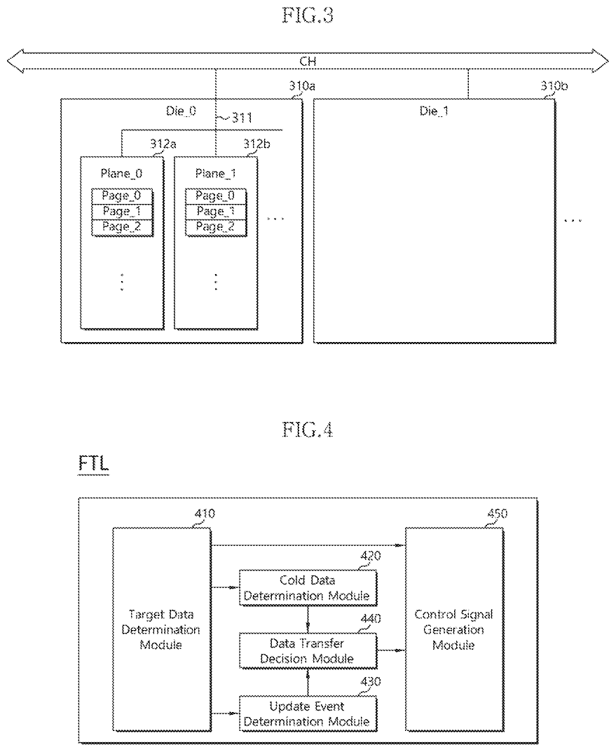

FIG. 2 illustrates the memory of FIG. 1.

Referring to FIG. 2, the memory 230 in accordance with an embodiment may include a first region R1 in which a flash translation layer (FTL) is stored and a second region R2 which is used as a command queue CMDQ for queuing a command corresponding to a request provided from the host device 20. Although not shown, the memory 230 may further include regions for various other uses, such as a region used as a write data buffer for temporarily storing write data, a region used as a read data buffer for temporarily storing read data, and a region used as a map cache buffer for caching map data, as is known in the art.

The memory 230 may include a region for storing system data or meta data, which is not illustrated. Workload pattern information (WLPI) may be stored in the region for storing system data or meta data in the memory 230.

When the nonvolatile memory device 100 is configured as a flash memory device, the processor 220 may control operation of the nonvolatile memory device 100, and drive the FTL, which may be software, in order to provide device compatibility to the host device 20. As the FTL is driven, the data storage device 10 may be recognized and used as a general data storage device such as a hard disk by the host device 20.

The FTL stored in the first region R1 of the memory 230 may include modules for performing various functions and meta data required for driving the respective modules. The FTL may be stored in a system region (not illustrated) of the nonvolatile memory device 100. When the data storage device 10 is powered on, the FTL may be read from the system region of the nonvolatile memory device 100 and loaded to the first region R1 of the memory 230.

FIG. 3 is a diagram illustrating a data storage region included in the nonvolatile memory device 100 in accordance with an embodiment.

Referring to FIG. 3, the nonvolatile memory device 100 may include a plurality of dies 310a and 310b which share a channel (CH) coupled to the controller 200, each of the dies may include a plurality of planes 312a and 312b which share a way 311 coupled to the channel, and each of the planes may include a plurality of pages. The page may indicate the minimum unit of storage used for reading or writing data. Furthermore, a plurality of pages which are collectively erased may be referred to as a block, and a plurality of blocks which are managed as one block may be referred to as a super block.

The nonvolatile memory device may include a plurality of data storage regions having different endurances, which are representative of different lifetimes or total operating times. In other words, each of data storage regions may accommodate a certain number of write operations for writing data and/or a certain number of erase operations for erasing stored data during its lifetime, either or both of which numbers may be different than those of the other regions. Furthermore, the data storage region may indicate a die, plane, super block, block, page, or other unit of storage.

By way of example, the present embodiment is described in the context of the nonvolatile memory device 100 including first and second dies 312a and 31b respectively which have different endurances. Moreover, the first die is denoted a first data storage region, and the second die is denoted a second data storage region.

FIG. 4 is a diagram illustrating a wear leveling manager of the FTL in accordance with an embodiment.

Referring to FIG. 4, the wear leveling manager may include a target data determination module 410, a cold data determination module 420, an update event determination module 430, a data transfer decision module 440 and a control signal generation module 450.

The target data determination module 410 may determine whether data which is to be processed by the data storage device 10 (target data) is stored in the data storage device 10.

In an embodiment, the target data determination module 410 may determine whether and, if so, where within the data storage device 10 the target data is stored, that is, whether the target data is stored in a first data storage region (in which case such data is referred to as first data) or is stored in a second storage region (in which case such data is referred to as second data). However, either or both of the first and second data may be transferred to another data storage region from the one in which it resides when this determination is made, as explained further below.

In an embodiment, the target data determination module 410 may determine whether the target data is not stored in the data storage device 10 (in which case the target data is referred to as third data). Third data is not stored in the data storage device 10 initially but may be stored therein later.

If the first or third data is stored in the second data storage region, the target data determination module 410 may determine that the stored data is the second data, when the corresponding data is processed later. If the second data is stored in the first data storage region, the target data determination module 410 may determine that the stored data is the first data, when the corresponding data is processed later.

The cold data determination module 420 may determine whether the target data is cold data or hot data. Specifically, the cold data determination module 420 may determine whether one or more of the first to third data correspond to cold data or hot data.

In an embodiment, the cold data determination module 420 may determine whether the target data is cold data or hot data, based on an access count (for example, write count or read count). Specifically, when an access count of the target data is greater than or equal to a first count (for example, 1,000), the cold data determination module 420 may determine that the target data is hot data. Furthermore, when the access count of the target data is greater than or equal to a second count (for example, 300) but less than the first count, the cold data determination module 420 may determine that the target data is cold data. The first and second counts may be variably set by a manufacturer or user, depending on the endurance of the nonvolatile memory device 100 or the purpose of use of the nonvolatile memory device 100.

In an embodiment, the cold data determination module 420 may determine whether data stored in a part of the plurality of data storage regions are cold data or hot data. Specifically, the nonvolatile memory device 100 may determine whether only data stored in any one of the first and second data storage regions is cold data or hot data. Furthermore, the cold data determination module 420 may determine whether data stored in a data storage region having lower or higher endurance than the other data storage region(s) is cold data or hot data.

The cold data determination module 420 may determine that the third data is cold data. That is, the wear leveling manager considers the third data as cold data initially, store the third data in the first or second data storage region, and then process the stored third data as cold data or hot data in consideration of the access count of the stored third data.

The update event determination module 430 may determine whether an update event for the target data occurs. Specifically, the update event determination module 430 may determine whether an overwrite event occurs, the overwrite event indicating that data stored in the nonvolatile memory device 100 was changed and the changed data needs to be stored in the nonvolatile memory device 100. Furthermore, when it is impossible to overwrite existing data as in a NAND flash memory device, the update event may indicate that the existing data was changed and the changed data needs to be stored.

In an embodiment, the update event determination module 430 may determine whether an update event for data stored in one or more of the plurality of data storage regions occurs. For example, the update event determination module 430 may determine whether an update event for the second data occurs, the second data being stored in the second data storage region.

The data transfer decision module 440 may decide whether to transfer the target data. Specifically, the data transfer decision module 440 may decide whether to transfer data from any one of the data storage regions into another data storage region. Furthermore, the data transfer decision module 440 may decide a data storage region to store the third data, which initially is not stored in the nonvolatile memory device 100, among the plurality of data storage regions. The data transfer may indicate that existing data is invalidated within a data storage region and a write operation is performed with the existing data on another data storage region, in the case of a NAND flash memory device or the like.

In an embodiment, the data transfer decision module 440 may decide whether to transfer the first data from the first data storage region to the second data storage region. For example, when the first data is determined as cold data, the data transfer decision module 440 may decide to transfer the first data to the second data storage region. When the first data is determined as hot data, the data transfer decision module 440 may decide not to transfer the first data to the second data storage region.

In an embodiment, the data transfer decision module 440 may decide whether to transfer the second data to the first data storage region. For example, when an update event for the second data is determined to have occurred, the data transfer decision module 440 may decide to transfer the second data to the first data storage region. When no update event for the second data is determined to have occurred, the data transfer decision module 440 may decide not to transfer the second data to the first data storage region.

The control signal generation module 450 may generate a control signal for controlling the nonvolatile memory device 100 based on the data transfer decision result. Specifically, when the first data is decided to be transferred, the control signal generation module 450 may generate a first control signal to store the first data in the second data storage region. The nonvolatile memory device 100 may perform a read operation of reading the first data from the first data storage region, and a write operation of storing the read first data in the second data storage region, according to the first control signal. When it is decided to transfer the second data, the control signal generation module 450 may generate a second control signal to store the second data in the first data storage region. The nonvolatile memory device 100 may perform a read operation of reading the second data from the second data storage region, and a write operation of storing the read second data in the first data storage region, according to the second control signal.

Regarding the third data, which initially is not stored in the nonvolatile memory device 100, the control signal generation module 450 may generate a control signal to store the third data in any one of the plurality of data storage regions. Specifically, the control signal generation module 450 may generate a third control signal to store the third data in the second data storage region. The nonvolatile memory device 100 may perform a write operation of storing the third data in the second data storage region, according to the third control signal.

FIG. 4 illustrates that the wear leveling manager serves as a part function of the FTL. However, this is only an example; the wear leveling manager can be configured as separate hardware such as a circuit.

FIG. 5 is a flowchart illustrating a wear leveling management method in accordance with an embodiment.

The method illustrated in FIG. 5 is described in the context of it being performed by the data storage device 10 illustrated in FIG. 1. However, such method may be performed by any suitable component(s) of the data storage device 10.

Referring to FIG. 5, the data storage device 10 may determine whether target data is cold data, at step S510. Specifically, the data storage device 10 may determine whether the target data is cold data or hot data, based on an access count of the target data.

In an embodiment, the data storage device 10 may determine whether data stored in one or more of the plurality of data storage regions are cold data or hot data. For example, the data storage device 10 may determine whether the first data stored in the first data storage region is cold data or hot data.

At step S520, the data storage device 10 may decide whether to transfer the target data determined as hot data or cold data at step S510. Specifically, the data storage device 10 may decide whether to transfer the target data stored in any one of the plurality of data storage regions to another data storage region, based on the determination result of step S510.

In an embodiment, the data storage device 10 may decide to transfer the target data (that is, “Yes” at step S520) determined as cold data at step S510. For example, when the first data stored in the first data storage region is determined as cold data at step S510, the data storage device 10 may decide to transfer the first data to the second data storage region at step S520.

In an embodiment, the data storage device 10 may decide not to transfer the target data (that is, “No” at step S520) when the target data is determined as hot data at step S510. For example, when the first data is determined as hot data at step S510, the data storage device 10 may decide not to transfer the first data to the second data storage region at step S520.

At step S530, the data storage device 10 may control the nonvolatile memory device 100 to store the target data in the second data storage region when the target data is the first data and determined as cold data.

One or more of the above-described steps may be performed at the same time as an operation of the data storage device 10 to process a command of the host device or to perform garbage collection or be performed before or after the operation of the data storage device 10. Furthermore, one or more of the above-described steps may be performed when the host device is idle, or performed as a background operation.

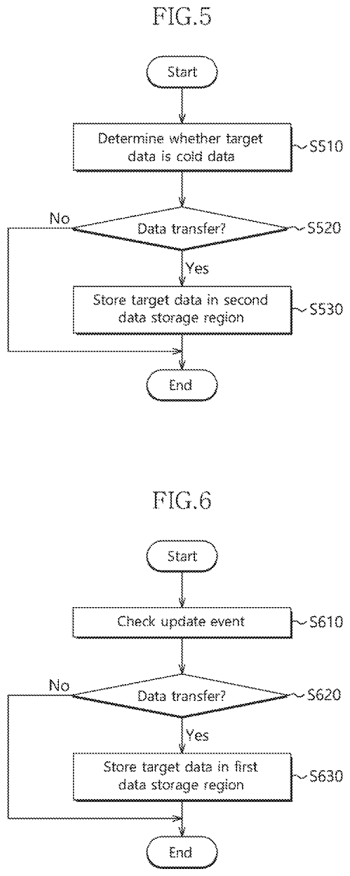

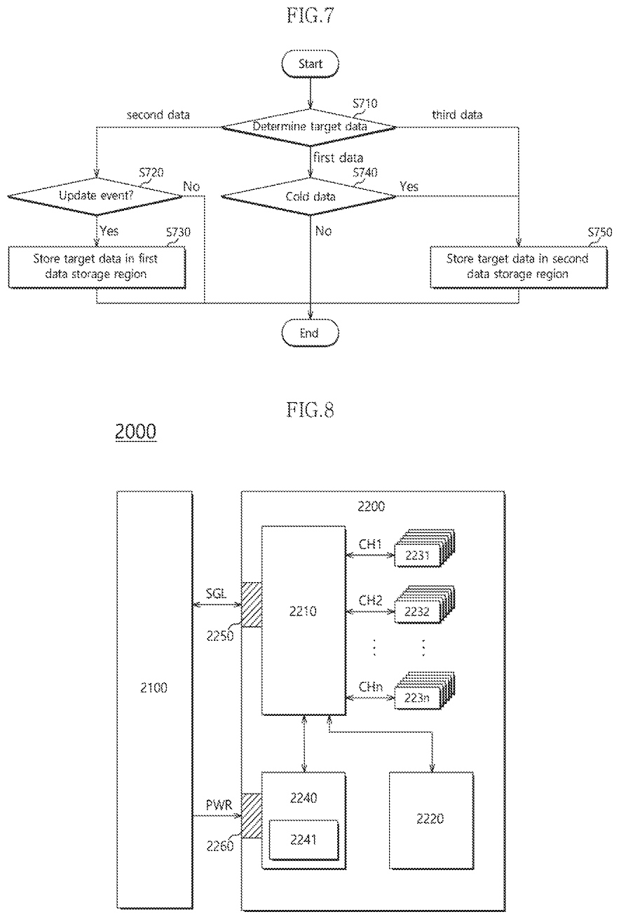

FIG. 6 is a flowchart illustrating a wear leveling management method in accordance with another embodiment.

The method illustrated in FIG. 6 is described in the context of it being performed by the data storage device 10 illustrated in FIG. 1. However, such method may be performed by any suitable component(s) of the data storage device 10.

Referring to FIG. 6, the data storage device 10 may check whether an update event occurs, at step S610. Specifically, the data storage device 10 may check whether an overwrite event occurs, the overwrite event indicating that the target data was changed and the changed data needs to be stored.

In an embodiment, the data storage device 10 may determine whether an update event for data stored in one or more of the plurality of data storage regions occurs. For example, the data storage device 10 may determine whether an update event for the second data stored in the second data storage region occurs.

At step S620, the data storage device 10 may decide whether to transfer the second data as the target data. Specifically, based on the result of step S610, the data storage device 10 may decide whether to transfer the target data from any one of the plurality of data storage regions to another data storage region.

In an embodiment, the data storage device 10 may decide whether to transfer the target data for which an update event is determined to have occurred. For example, when an update event for the second data stored in the second data storage region is determined to have occurred, the data storage device 10 may decide to transfer the second data to the first data storage region (that is, “Yes” at step S620).

In an embodiment, the data storage device 10 may decide not to transfer the target data for which no update event is determined to have occurred. For example, when no update event for the second data is determined to have occurred, the data storage device 10 may decide not to transfer the second data to the first data storage region (that is, “No” at step S620).

At step S630, the data storage device 10 may control the nonvolatile memory device 100 to store the target data in the first data storage region when the target data is the second data and an update event for the target data is determined to have occurred.

One or more of the above-described steps may be performed at the same time as an operation of the data storage device 10 to process a command of the host device or to perform garbage collection or be performed before or after the operation of the data storage device 10. Furthermore, one or more of the above-described steps may be performed when the host device is idle, or performed as a background operation.

FIG. 7 is a flowchart illustrating a wear leveling management method in accordance with still another embodiment.

The method illustrated in FIG. 7 is described in the context of it being performed by the data storage device 10 illustrated in FIG. 1. However, such method may be performed by any suitable component(s) of the data storage device 10.

Referring to FIG. 7, the data storage device 10 may determine whether the target data is data stored in the data storage device 10 at step S710.

In an embodiment, the data storage device 10 may determine whether the target data is the first data stored in the first data storage region or the second data stored in the second data storage region.

As part of step S710 data storage device 10 may also determine whether the target data is the third data, which initially is not stored in the data storage device 10.

The process proceeds to step S740 when the target data is determined as the first data, proceeds to step S720 when the target data is determined as the second data and proceeds to step S750 when the target data is determined as the third data.

At step S720, the data storage device 10 may determine whether an update event occurs on the second data. Specifically, the data storage device 10 may check whether an overwrite event occurs on the second data, the overwrite event indicating that the second data was changed and the changed second needs to be stored.

In an embodiment, the data storage device 10 may determine whether an update event for data stored in one or more of the plurality of data storage regions occurs. For example, the data storage device 10 may determine whether an update event for the second data stored in the second data storage region of the first and second data storage regions occurs.

The data storage device 10 may decide not to transfer the target data for which no update event is determined to have occurred.

For example, when no update event for the second data is determined to have occurred, the data storage device 10 may decide not to transfer the second data to the first data storage region (that is, “No” at step S720).

At step S730, the data storage device 10 may store the second data in the first data storage region when an update event for the second data occurs in the second data storage region (that is, “Yes” at step S720). Specifically, the data storage device 10 may decide to transfer the second data for which an update event is determined to have occurred. For example, when an update event for the second data stored in the second data storage region is determined to have occurred, the data storage device 10 may decide to transfer the second data to the first data storage region.

At step S740, the data storage device 10 may determine whether the first data is cold data based on an access count of the first data.

In an embodiment, the data storage device 10 may determine whether data stored in one or more of the plurality of data storage regions are cold data or hot data. For example, the data storage device 10 may determine whether the first data stored in the first data storage region is cold data or hot data.

The data storage device 10 may decide not to transfer the target data determined as hot data (that is, “No” at step S740). For example, when the first data is determined as hot data, the data storage device 10 may decide not to transfer the first data to the second data storage region. Thus, if the first data is determined as hot data at step S740, the process ends.

At step S750, the data storage device 10 may store the third data (that is, when the target data is determined as the third data at step S710) and the first data determined to be “cold” (that is, “Yes” at step S740) in the second data storage region. Specifically, the data storage device 10 may decide whether to transfer data stored in any one of the plurality of data storage regions to another data storage region, based on the result of steps S710 and S740. When the target data is determined as the first data and cold data at steps S710 and S740, the data storage device 10 may control the nonvolatile memory device 100 to store the first cold data in the second data storage region.

The data storage device 10 may control the nonvolatile memory device 100 to store the third data in the second data storage region.

One or more of the above-described steps may be performed at the same time as an operation of the data storage device 10 to process a command of the host device or to perform garbage collection or be performed before or after the operation of the data storage device 10. Furthermore, one or more of the above-described steps may be performed when the host device is idle, or performed as a background operation.

FIG. 8 illustrates a data processing system 2000 including a solid state drive (SSD) in accordance with an embodiment. The data processing system 2000 may include a host device 2100 and an SSD 2200.

The SSD 2200 may include a controller 2210, a buffer memory device 2220, nonvolatile memory devices 2231 to 223n, a power supply 2240, a signal connector 2250 and a power connector 2260.

The controller 2210 may control overall operations of the SSD 2200.

The buffer memory device 2220 may temporarily store data which are to be stored in the nonvolatile memory devices 2231 to 223n. Furthermore, the buffer memory device 2220 may temporarily store data read from the nonvolatile memory devices 2231 to 223n. The data which are temporarily stored in the buffer memory device 2220 may be transferred to the host device 2100 or the nonvolatile memory devices 2231 to 223n under control of the controller 2210.

The nonvolatile memory devices 2231 to 223n may be used as storage media of the SSD 2200. The nonvolatile memory devices 2231 to 223n may be coupled to the controller 2210 through a plurality of channels CH1 to CHn. One or more nonvolatile memory devices may be coupled to one channel. The nonvolatile memory devices coupled to one channel may be coupled to the same signal bus and data bus.

The power supply 2240 may provide power PWR inputted through the power connector 2260 into the SSD 2200. The power supply 2240 may include an auxiliary power supply 2241. The auxiliary power supply 2241 may supply power to properly turn off the SSD 2200, when a sudden power off occurs. The auxiliary power supply 2241 may include large capacitors capable of storing power PWR.

The controller 2210 may exchange signals SGL with the host device 2100 through the signal connector 2250. The signal SGL may include a command, address, and data. The signal connector 2250 may be configured as any of various types of connectors depending on an interface method between the host device 2100 and the SSD 2200.

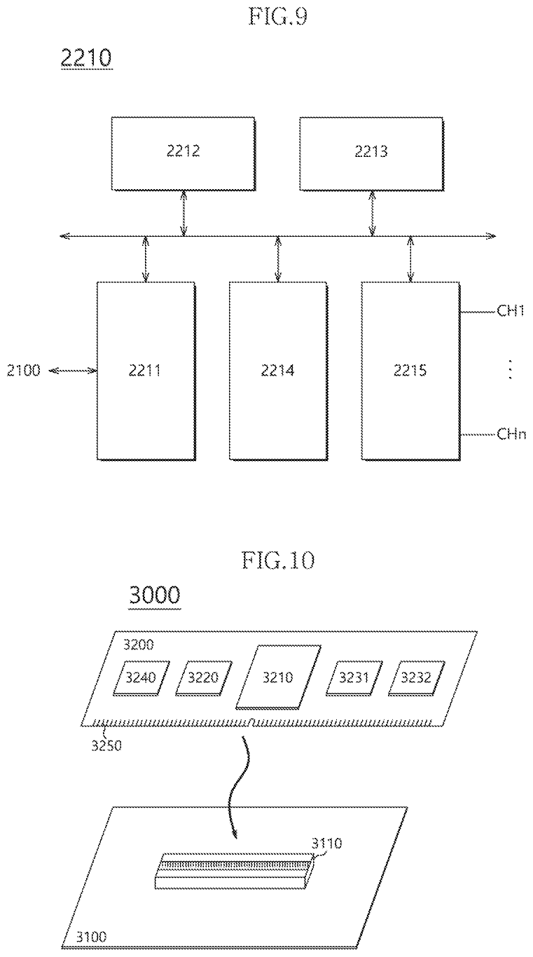

FIG. 9 illustrates a configuration of the controller of FIG. 8. Referring to FIG. 9, the controller 2210 may include a host interface 2211, a control component 2212, a RAM 2213, an ECC component 2214 and a memory interface 2215.

The host interface 2211 may interface the host device 2100 and the SSD 2200 according to a protocol of the host device 2100. For example, the host interface 2211 may communicate with the host device 2100 through any of the following protocols: secure digital, USB (Universal Serial Bus), MMC (Multi-Media Card), eMMC (Embedded MMC), PCMCIA (Personal Computer Memory Card International Association), PATA (Parallel Advanced Technology Attachment), SATA (Serial Advanced Technology Attachment), SCSI (Small Computer System Interface), SAS (Serial Attached SCSI), PCI (Peripheral Component Interconnection), PCI-E (PCI Express) and UFS (Universal Flash Storage). The host interface unit 2211 may perform a disk emulation function which supports the host device 2100 to recognize the SSD 2200 as a universal data storage device, for example, a hard disk drive (HDD).

The control component 2212 may analyze and process the signal SGL inputted from the host device 2100. The control component 2212 may control operations of internal function blocks according to firmware or software for driving the SSD 2200. The RAM 2213 may be used as a working memory for driving such firmware or software.

The ECC component 2214 may generate parity data of the data which are to be transferred to the nonvolatile memory devices 2231 to 223n. The generated parity data and the data may be stored in the nonvolatile memory devices 2231 to 223n of FIG. 8. The ECC component 2214 may detect an error of data read from the nonvolatile memory devices 2231 to 223n based on the parity data. When the detected error falls within a correctable range, the ECC component 2214 may correct the detected error.

The memory interface 2215 may provide a control signal such as a command and address to the nonvolatile memory devices 2231 to 223n, under control of the control component 2212. The memory interface 2215 may exchange data with the nonvolatile memory devices 2231 to 223n, under control of the control component 2212. For example, the memory interface 2215 may provide data stored in the buffer memory device 2220 to the nonvolatile memory devices 2231 to 223n, or provide data read from the nonvolatile memory devices 2231 to 223n to the buffer memory device 2220.

FIG. 10 illustrates a data processing system 3000 including a data storage device in accordance with an embodiment. The data processing system 3000 may include a host device 3100 and a data storage device 3200.

The host device 3100 may be configured as a board such as a printed circuit board (PCB). Although not illustrated, the host device 3100 may include internal function blocks for performing a function of the host device 3100.

The host device 3100 may include a connection terminal 3110 such as a socket, slot or connector. The data storage device 3200 may be mounted on the connection terminal 3110.

The data storage device 3200 may be configured as a board such as a PCB. The data storage device 3200 may be referred to as a memory module or memory card. The data storage device 3200 may include a controller 3210, a buffer memory device 3220, nonvolatile memory devices 3231 and 3232, a power management integrated circuit (PMIC) 3240 and a connection terminal 3250.

The controller 3210 may control overall operations of the data storage device 3200. The controller 3210 may be configured in the same manner as the controller 2210 illustrated in FIG. 9.

The buffer memory device 3220 may temporarily store data which are to be stored in the nonvolatile memory devices 3231 and 3232. Furthermore, the buffer memory device 3220 may temporarily store data read from the nonvolatile memory devices 3231 and 3232. The data which are temporarily stored in the buffer memory device 3220 may be transferred to the host device 3100 or the nonvolatile memory devices 3231 and 3232 under control of the controller 3210.

The nonvolatile memory devices 3231 to 3232 may be used as storage media of the data storage device 3200.

The PMIC 3240 may provide power inputted through the connection terminal 3250 into the data storage device 3200. The PMIC 3240 may manage the power of the data storage device 3200 under control of the controller 3210.

The connection terminal 3250 may be coupled to the connection terminal 3110 of the host device 3100. Through the connection terminal 3250, signals and power may be transferred between the host device 3100 and the data storage device 3200, the signals including a command, address, and data. The connection terminal 3250 may be configured in various ways, depending on an interface method between the host device 3100 and the data storage device 3200. The connection terminal 3250 may be disposed at or on any side of the data storage device 3200.

FIG. 11 illustrates a data processing system 4000 including a data storage device in accordance with an embodiment. The data processing system 4000 may include a host device 4100 and a data storage device 4200.

The host device 4100 may be configured as a board such as a PCB. Although not illustrated, the host device 4100 may include internal function blocks for performing a function of the host device.

The data storage device 4200 may be configured as a surface mount package. The data storage device 4200 may be mounted on the host device 4100 through solder balls 4250. The data storage device 4200 may include a controller 4210, a buffer memory device 4220 and a nonvolatile memory device 4230.

The controller 4210 may control overall operations of the data storage device 4200. The controller 4210 may be configured in the same manner as the controller 2210 illustrated in FIG. 9.

The buffer memory device 4220 may temporarily store data which are to be stored in the nonvolatile memory device 4230. Furthermore, the buffer memory device 4220 may temporarily store data read from the nonvolatile memory device 4230. The data which are temporarily stored in the buffer memory device 4220 may be transferred to the host device 4100 or the nonvolatile memory device 4230 under control of the controller 4210.

The nonvolatile memory device 4230 may be used as a storage medium of the data storage device 4200.

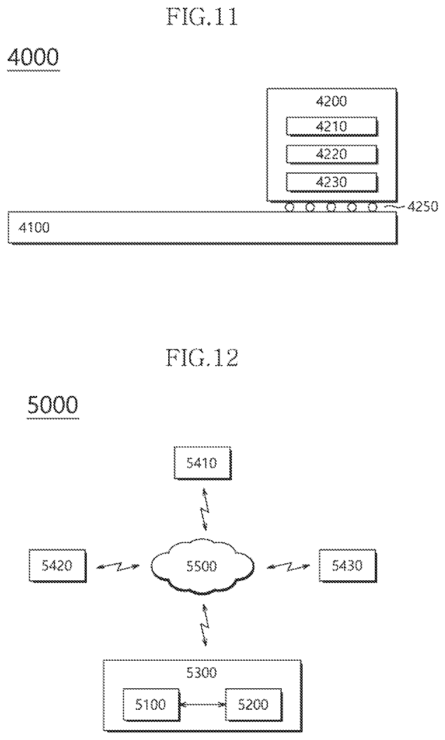

FIG. 12 illustrates a network system 5000 including a data storage device in accordance with an embodiment of the present invention. Referring to FIG. 12, the network system 5000 may include a server system 5300 and a plurality of client systems 5410 to 5430 which are connected through a network 5500.

The server system 5300 may provide data in response to requests of the plurality of client systems 5410 to 5430. For example, the server system 5300 may store data provided from the plurality of client systems 5410 to 5430. For another example, the server system 5300 may provide data to the plurality of client systems 5410 to 5430.

The server system 5300 may include a host device 5100 and a data storage device 5200. The data storage device 5200 may be configured as the data storage device 10 of FIG. 1, the data storage device 2200 of FIG. 8, the data storage device 3200 of FIG. 10 or the data storage device 4200 of FIG. 11.

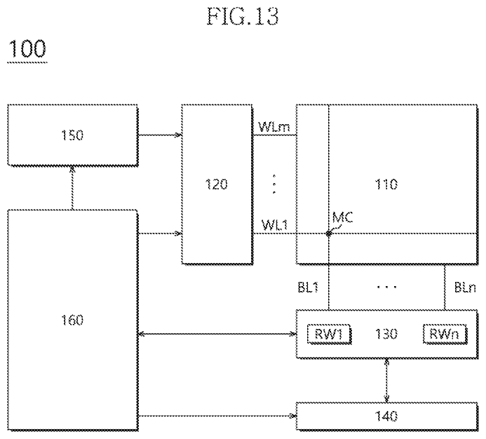

FIG. 13 is a block diagram illustrating a nonvolatile memory device 100 included in a data storage device in accordance with an embodiment. Referring to FIG. 13, the nonvolatile memory device 100 may include a memory cell array 110, a row decoder 120, a column decoder 130, a data read/write block 140, a voltage generator 150 and control logic 160.

The memory cell array 110 may include memory cells MC arranged at the respective intersections between word lines WL1 to WLm and bit lines BL1 to BLn.

The row decoder 120 may be coupled to the memory cell array 110 through the word lines WL1 to WLm. The row decoder 120 may operate under control of the control logic 160. The row decoder 120 may decode an address provided from an external device (not illustrated). The row decoder 120 may select and drive the word lines WL1 to WLm based on the decoding result. For example, the row decoder 120 may provide word line voltages received from the voltage generator 150 to the word lines WL1 to WLm.

The data read/write block 140 may be coupled to the memory cell array 110 through the bit lines BL1 to BLn. The data read/write block 140 may include read/write circuits RW1 to RWn corresponding to the respective bit lines BL1 to BLn. The data read/write block 140 may operate under control of the control logic 160. The data read/write block 140 may operate as a write driver or sense amplifier depending on operation modes. For example, the data read/write block 140 may operate as a write driver which stores data provided from the external device in the memory cell array 110, during a write operation. For another example, the data read/write block 140 may operate as a sense amplifier which reads data from the memory cell array 110, during a read operation.

The column decoder 130 may operate under control of the control logic 160. The column decoder 130 may decode an address provided from the external device. The column decoder 130 may couple the read/write circuits RW1 to RWn of the data read/write block 140, corresponding to the respective bit lines BL1 to BLn, to a data input/output line (or data input/output buffer) according to the decoding result.

The voltage generator 150 may generate a voltage which is used for an internal operation of the nonvolatile memory device 100. The voltages generated by the voltage generator 150 may be applied to the memory cells of the memory cell array 110. For example, a program voltage generated during a program operation may be applied to a word line of memory cells on which the program operation is to be performed. For another example, an erase voltage generated during an erase operation may be applied to well regions of memory cells on which the erase operation is to be performed. For another example, a read voltage generated during a read operation may be applied to a word line of memory cells on which the read operation is to be performed.

The control logic 160 may control overall operations of the nonvolatile memory device 100 based on a control signal provided from the external device. For example, the control logic 160 may control an operation of the nonvolatile memory device 100, such as a read, write or erase operation of the nonvolatile memory device 100.

In accordance with embodiments, the lifetime of the memory device can be effectively extended.

While various embodiments have been illustrated and described, it will be understood by those skilled in the art that the embodiments described are examples only. Accordingly, the present invention is not limited based on the described embodiments. Rather, the present invention encompasses all modifications and variations that fall within the scope of the claims.

What is claimed is:

1. A data storage device comprising:
a nonvolatile memory device comprising a first data storage region and a second data storage region which have different endurances, the nonvolatile memory device being configured to perform one or more of an erase operation, a write operation and a read operation on the first and second data storage regions; and
a controller configured to determine whether an update event occurs in which second data stored in the second data storage region is changed, and control the nonvolatile memory device to transfer the second data to the first data storage region based on the update event determination result.

2. The data storage device according to claim 1, wherein the controller controls the nonvolatile memory device to store third data, which is initially not stored in the nonvolatile memory device, in the second data storage region.

3. The data storage device according to claim 2, wherein the controller further determines whether first data stored in the first data storage region is cold data, and controls the nonvolatile memory device to transfer the first data to the second data storage region based on the cold data determination result.

4. The data storage device according to claim 1, wherein the first data storage region has higher endurance than the second data storage region.

5. The data storage device according to claim 1, wherein the controller controls the nonvolatile memory device to transfer the second data, to the first data storage region when the update event is determined to have occurred.

6. The data storage device according to claim 3, wherein the controller controls the nonvolatile memory device to transfer the first data to the second data storage region when the first data is determined as the cold data.

7. The data storage device according to claim 1, wherein the controller further determines whether data to be processed in the nonvolatile memory device corresponds to any of a first data which is stored in the first data storage region, the second data, and a third data which is not stored in the nonvolatile memory device.

8. The data storage device according to claim 1, wherein the controller controls the nonvolatile memory device to perform data transfer during an idle mode or garbage collection.

9. An operating method of a data storage device, the method comprising:
determining whether an update event in which second data is changed occurs, the second data being data stored in a second data storage region included in a nonvolatile memory device;
deciding whether to transfer the second data based on the update event determination result; and
controlling the nonvolatile memory device to transfer the second data to a first data storage region based on the second data transfer decision result, the first data storage region being included in the nonvolatile memory device and having different endurance from the second data storage region.

10. The operating method according to claim 9, further comprising controlling the nonvolatile memory device to store third data in the second data storage region, the third data being data which is not stored in the nonvolatile memory device.

11. The operating method according to claim 10, further comprising:
determining whether first data is cold data, the first data being data stored in the first data storage region included in the nonvolatile memory device;
deciding whether to transfer the first data based on the cold data determination result; and
controlling the nonvolatile memory device to transfer the first data to the second data storage region based on the first data transfer decision result.

12. The operating method according to claim 9, wherein the first data storage region has higher endurance than the second data storage region.

13. The operating method according to claim 9, wherein the deciding whether to transfer the second data comprises deciding to transfer the second data to the first data storage region when the update event is determined to occur.

14. The operating method according to claim 11, wherein the deciding whether to transfer the first data comprises deciding to transfer the first data to the second data storage region when the first data is determined as the cold data.

15. The operating method according to claim 9, further comprising determining whether data to be processed in the nonvolatile memory device corresponds to any one of a first data which is stored in the first data storage region, the second data which is data stored in the second data storage region, and a third data which is not stored in the nonvolatile memory device.

16. The operating method according to claim 9, wherein the controlling of the nonvolatile memory device comprises controlling the nonvolatile memory device to perform data transfer during an idle mode or garbage collection.
